(19) United States
(12) Patent Application Publication
(10) Pub. No.: US 2025/0108588 A1
(43) Pub. Date: Apr. 3, 2025

(54) FILM LAMINATE FOR WHEEL ADHESION

(71) Applicant: Sumiron Co., Ltd., Osaka (JP)

(72) Inventors: Yuta AMAKO, Osaka (JP); Tomohiko OKAYAMA, Osaka (JP); Takaaki MORI, Osaka (JP); Naoya NISHIZAKI, Osaka (JP)

(73) Assignee: Sumiron Co., Ltd., Osaka (JP)

(21) Appl. No.: 18/833,233

(22) PCT Filed: Mar. 15, 2022
(86) PCT No.: PCT/JP2022/011460

§ 371 Date: Jul. 25, 2024

(30) Foreign Application Priority Data
Jan. 28, 2022 (JP) 2022-011440

(51) Int. Cl. B32B 27/08; B32B 3/26; B32B 3/30; B32B 7/02; B32B 7/12; B60B 7/06

(52) U.S. Cl. CPC B32B 27/08; B32B 3/266; B32B 3/30; B32B 7/02; B32B 7/12; B32B 2307/538; B32B 2307/712; B32B 2307/7376; B32B 2405/00; B60B 7/06; B60B 2310/318; B60B 2900/133; B60B 2900/211

(57) ABSTRACT

A film laminate to be applied to wheels capable of reducing peeling charge voltage generated during peeling of a film to be applied to wheels and peeling noise generated during such peeling is provided. The film laminate to be applied to wheels includes a plurality of film sheets A to be applied to wheels having a base film 1 and an adhesive layer 2 provided on the base film 1, the base film 1 having a surface roughness of 0.05 to 1.50 μm in arithmetic mean roughness (Ra) and 0.25 to 2.50 μm in maximum height (Ry).

### TECHNICAL FIELD

The present invention relates to a film laminate to be applied to wheels used to prevent rust from forming on wheels of tires, and brake discs of automobiles and other vehicles, and to prevent such wheels from being scratched and to protect them.

### BACKGROUND ART

Previously, as this type of the film laminate to be applied to wheels, there exists, for example, in anti-corrosion covers, each of which is provided with a cover member covering a wheel of an automobile tire and an adhesive layer peelably adhering the cover member to a side surface of the wheel (Patent Literature 1).

The anti-corrosion covers are laminated in hundreds of sheets, and the cover members are peeled off one by one and adhered to the side surface of the tire wheel.

This prevents contamination of the adhesive layer until just prior to adhesion, eliminating adhesion failure due to the contamination.

In addition, as this type of the film laminate to be applied to wheels, there exists a laminate of a plurality of film sheets to be applied to wheels having a base film and an adhesive layer provided on the base film (Patent Literature 2).

The film laminate to be applied to wheels is adhered to the tire wheel with the adhesive surface where the adhesive layer is exposed, and the film laminate to be applied to wheels, except for the film to be applied to wheels where the adhesive layer is in contact with this wheel, is peeled off.

This enables high working efficiency in adhering the film to be applied to wheels and effectively prevents the disc brake of the automobile from rusting.

In addition, as this type of the film laminate to be applied to wheels, there exists a laminate of a plurality of film sheets to be applied to wheels having a base film and an adhesive layer provided on the base film, wherein a flexural modulus of the base film (in accordance with JISK7171: 2008) is 100 to 600 MPa (Patent Literature 3).

In the film laminate to be applied to wheels, a portion of the adhesive layer is exposed by peeling off a portion of a sheet of film to be applied to wheels on the side where the base film surface is exposed, and this exposed adhesive layer is adhered to the wheel, and while the film to be applied to wheels that is partially adhered to this wheel is peeled off from the laminate, the entire surface of the adhesive layer of the film to be applied to wheels is adhered to the wheel.

This enables high working efficiency in adhering the film to be applied to wheels and effectively prevents the disc brake of the automobile from rusting, as well as effectively prevents unwanted wrinkles, creases, etc. from appearing on the film to be applied to wheels.

### CITATION LIST

### Patent Literature

Patent Literature 1: Japanese Patent No. 3879985
Patent Literature 2: Japanese Patent No. 5855505
Patent Literature 3: Japanese Patent No. 5934541

### SUMMARY OF INVENTION

### Technical Problem

As for the film laminate to be applied to wheels described above, when a sheet of film to be applied to wheels is adhered to a wheel of a tire of automobiles or other vehicles, a sheet of film to be applied to wheels is peeled off from this laminate, but at that time, a high peeling charge voltage is generated, which attracts dust and other particles, and the dust and other particles are adhered to the film to be applied to wheels. Therefore, when the film to be applied to wheels is adhered to the wheel, the dust and other particles remain adhered to the film, and there has been a problem that the appearance of the wheel is damaged.

In addition, there have been problems that a loud peeling noise is generated, which made a workplace noisy and caused hearing loss and other health problems for workers when a sheet of film to be applied to wheels is peeled off from the film laminate to be applied to wheels.

Therefore, the present invention has been made to solve the conventional problems described above, and an objective of the present invention is to provide a film laminate to be applied to wheels which can reduce the peeling charge voltage generated when a film to be applied to wheels is peeled off, as well as the peeling noise generated during such peeling.

### Solution to Problem

Therefore, the film laminate to be applied to wheels of the present invention includes a plurality of film sheets A to be applied to wheels including a base film 1 and an adhesive layer 2 provided on the base film 1, the base film 1 having surface roughness of 0.05 to 1.50 μm in arithmetic mean roughness (Ra) and 0.25 to 2.50 μm in maximum height (Ry).

Furthermore, in the film laminate to be applied to wheels of the present invention, the base film 1 contains an additive to improve weather resistance.

Furthermore, in the film laminate to be applied to wheels of the present invention, the base film 1 is subjected to a treatment to improve adhesion with the adhesive layer 2.

And in the film laminate to be applied to wheels of the present invention, the base film 1 includes three layers of a first layer 13, a second layer 14, and a third layer 15.

Furthermore, in the film laminate to be applied to wheels of the present invention, a thickness ratio of the first layer 13, the second layer 14, and the third layer 15 of the base film 1 is about 1:5:1.

Furthermore, in the film laminate to be applied to wheels of the present invention, a surface of the first layer 13 of the base film 1 is made into a micro-convex structure 17 by sea-island structuring of a base resin and an incompatible resin.

### Advantageous Effect of Invention

The film laminate to be applied to wheels of the present invention can reduce the peeling charge voltage generated when the film to be applied to wheels is peeled off, thereby preventing dust and other particles from adhering to this film, and when the film is adhered to the wheel, it does not damage the appearance of the wheel.

In addition, the film laminate to be applied to wheels of the present invention can reduce the peeling noise generated when the film to be applied to wheels is peeled off, thereby making the workplace less noisy and not causing health problems to the workers.

### BRIEF DESCRIPTION OF DRAWINGS

FIG. 1 is a perspective view illustrating an embodiment of a film laminate to be applied to wheels of the present invention.

FIG. 2 is a perspective view illustrating another embodiment of the film laminate to be applied to wheels of the present invention.

FIG. 3 is a partially enlarged cross-sectional view of a sheet of film to be applied to wheels of the film laminate to be applid to wheels of the present invention.

### DESCRIPTION OF EMBODIMENT

Hereinafter, embodiments of a film laminate to be applied to wheels of the present invention will be described in detail with reference to drawings.

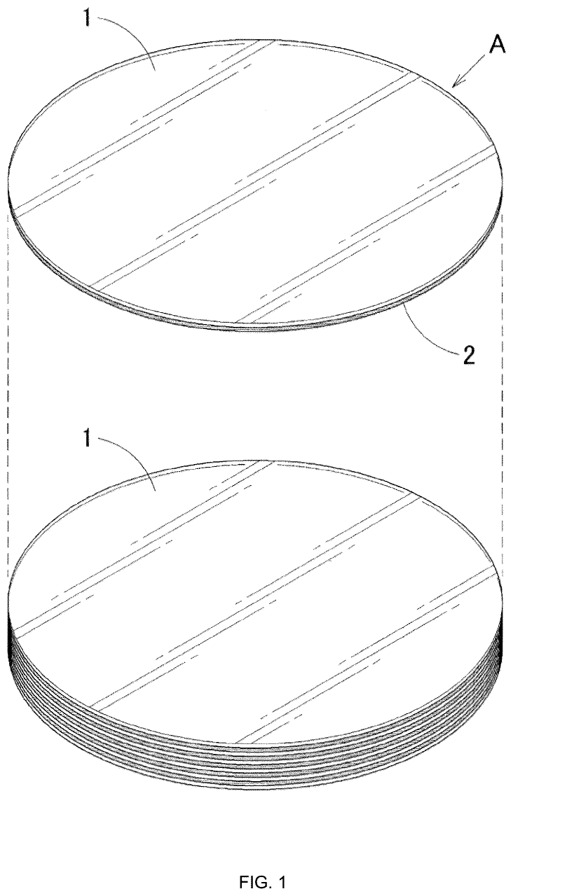

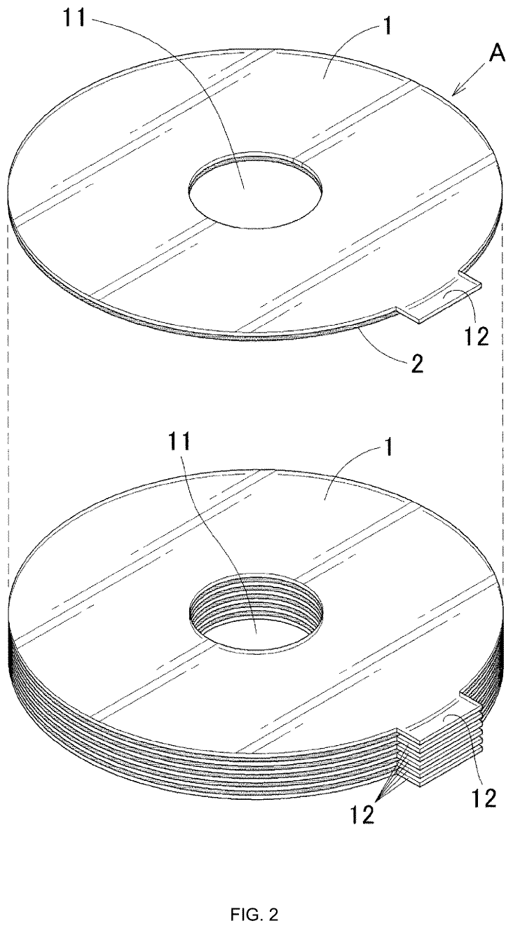

As illustrated in FIGS. 1 and 2, the film laminate to be applied to wheels of the present invention is a laminate of a plurality of film sheets A to be applied to wheels including a base film 1 and an adhesive layer 2 provided on the base film 1.

The film A to be applied to wheels is formed in a circular shape having approximately the same diameter as that of wheels of automobiles or other vehicles to be adhered, and in that illustrated in FIG. 2, an open hole 11 is formed in a concentric circle in the center. This open hole 11 is for inspecting, for example, the state of tightness of bolts attached to the wheel after the film A to be applied to wheels is adhered to the wheel.

Furthermore, in the film A to be applied to wheels, in that as illustrated in FIG. 2, a peeling tab 12 protruding outwardly from a portion of the periphery is formed. The peeling tab 12 is designed to be picked up with fingers and peel the film A to be applied to wheels sheet by sheet from the film laminate to be applied to wheels, and can be an approximately rectangular shape or an approximately semicircular shape, etc., and is sufficient if it is of minimum size to be picked up with fingers. The peeling tab 12 can be made to protrude outwardly from multiple portions of the periphery, and further, if necessary, can be made to protrude outwardly from the entire periphery. In this way, the peeling tab 12 is easier to pick up because there are more places to pick it up, and the work of peeling the film A to be applied to wheels is facilitated.

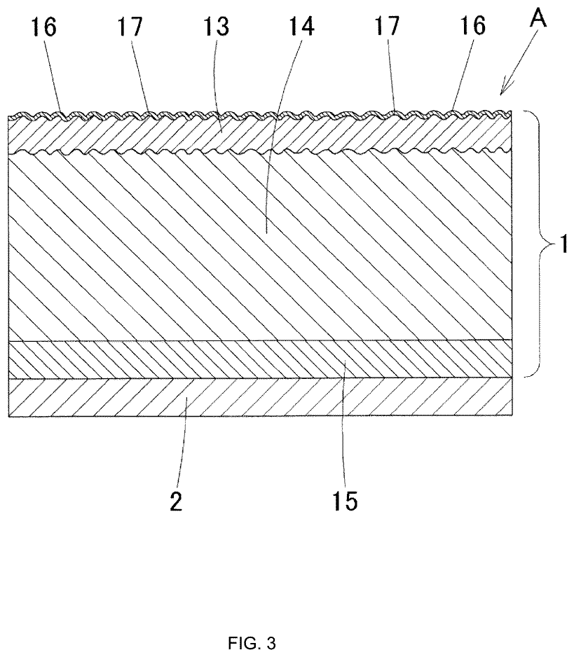

In the film laminate to be applied to wheels of the present invention, the base film 1 is preferably three layers of a first layer 13, a second layer 14, and a third layer 15, as illustrated in FIG. 3, but it can also be a single layer film, or a laminated film with two or four or more layers.

The base film 1 has surface roughness of 0.05 to 1.50 μm in arithmetic mean roughness (Ra) and 0.25 to 2.50 μm in maximum height (Ry), preferably 0.05 to 1.00 μm in arithmetic mean roughness (Ra) and 0.25 to 2.00 μm in maximum height (Ry), more preferably 0.05 to 0.50 μm in arithmetic mean roughness (Ra) and 0.5 to 1.50 μm in the maximum height (Ry). The measurement of the arithmetic mean roughness (Ra) and maximum height (Ry) was made in accordance with JIS-B 06015 (1994). The measuring instrument used was a CS-H5000CNC surface roughness/contour measuring instrument (produced by Mitutoyo Corporation).

Materials of the base film 1 include low-density polyethylene, linear low-density polyethylene, medium density polyethylene, high density polyethylene, homopolypropylene, random polypropylene, an olefinic thermoplastic elastomer, an ethylene-vinyl acetate copolymer, soft polyvinyl chloride, etc.

A thickness of the base film 1 is not limited, but in general it is preferably 20 to 200 μm, particularly preferably 30 to 100μ m.

In the base film 1, an additive to improve weather resistance can be contained. For example, a UV absorber can be contained so that a spectral transmittance in a wavelength range of 300 to 380 nm is 0 to 20%. A content ratio of the UV absorber is preferably 0.005 to 2% by mass. By containing the UV absorber, the weather resistance of the base film 1 can be improved; the adhesive layer 2 can be protected from UV rays; and the film A to be applied to wheels can be peeled off without leaving adhesive residue on the wheel.

Specific examples of UV absorbers include triazine based, benzophenone based, benzotriazole based, cyanoacrylate based, and other UV absorbers. One or more of these UV absorbers can be used in combination.

In addition to the UV absorber, the base film 1 may also contain weathering aids such as a light stabilizer and an antioxidant.

On the surface of the opposite side of the base film 1 where the adhesive layer 2 is provided, a release agent layer 16 may be provided, as illustrated in FIG. 3. By providing this release agent layer 16, the film A to be applied to wheels can be peeled off from the film laminate to be applied to wheels with less force. This prevents the film A to be applied to wheels from being twisted by excessive resistance force when being peeled off, rendering it unusable, or from being stretched too much so that it does not match the dimension to be adhered together. In addition, even after the film laminate to be applied to wheels has been stored for a long period of time, peeling defects are less likely to occur and the film A to be applied to wheels can be peeled off easily.

The base film 1 may contain known additives such as a heat resistant stabilizer, an antioxidant stabilizer, a weathering stabilizer, a UV absorber, and an antistatic agent. In addition, the base film 1 may be subjected to a corona discharge treatment, a glow discharge treatment, a plasma treatment, a flame treatment, an ozone treatment, an ultraviolet irradiation treatment, an electron beam irradiation treatment, or a radiation irradiation treatment, etc. to improve adhesion with the adhesive layer 2. The base film 1 may also be subjected to an easy-adhesion treatment such as a sandblasting treatment, an embossing treatment, and formation of an easy-adhesion undercoat.

In the base film 1, the first layer 13 and the third layer 15 should be hard layers and the second layer 14 should be a soft layer, and it is preferable that a ratio of the thickness of the first layer 13, the second layer 14, and the third layer 15 is about 1:5:1. At this ratio of about 1:3:1, it is too hard, and at this ratio of about 1:7:1, it is too soft, which is not desirable. If the base film 1 is too soft, the film will stretch when adhering and then shrink over time, resulting in residual strain, and causing floating between the film and the wheel surface to be adhered. If the base film 1 is too hard, there will be happened a position where the film will not adhere to a curved surface of the wheel.

Furthermore, with such a ratio, the first layer 13 can be formed as a relatively thin surface layer and an amount of resin used in the first layer 13 can be reduced. This makes the film superior in price and workability, and also facilitates incorporation of an incompatible resin described later, and avoids a decrease in film strength due to the incorporation of the incompatible resin. In addition, by forming the multilayer structure with resins having different thermal shrinkage, heat deformation and thermal degradation after the film is adhered can be suppressed.

It is preferable that the second layer 14, in particular, has its own upper surface deformed to follow a micro-convex structure of the first layer 13 described later, and its own lower surface is flat. At this time, the second layer 14 contacts the first layer 13 and absorbs deformation of the micro-convex structure of the underside of the first layer 13, and a surface in contact with the adhesive layer 2 is flat and smooth (flat). This stabilizes fixability of the adhesive layer 2 to the base film 1. In addition, by keeping the adhesive surface of the adhesive layer 2 flat before layering, it becomes easier to adjust adhesive force by layering.

The first layer 13 of the base film 1 is made by forming a film from a thermally melted liquid of the incompatible resin mixed with a base resin made of a general polypropylene resin (PP) or polyethylene resin (PE) or the like, and a surface of this first layer 13 has the micro-convex structure 17 formed by sea-island structuring of the base resin and the incompatible resin. The incompatible resin preferably has a higher thermal decomposition temperature than that of the base resin, and a different viscosity when thermally melted than that of the base resin. If this is the case, the incompatible resin mixed into the film will not be denatured during film formation, thereby preventing burning and thermal degradation due to film formation of the first layer.

The incompatible resin has a higher thermal decomposition temperature than that of the general base resins such as PP and PE, and has a different viscosity when thermally melted than that of the base resin. This prevents the incompatible resin from degenerating even when heated to the thermal decomposition temperature of the base resin during the film formation. This incompatible resin is preferably any one of an ethylene-methyl methacrylate (EMMA) copolymer or an ethylene-methyl acrylate (EMA) copolymer among low-density polyethylene (LDPE) resins. Since ethylene or polyethylene resins such as EMMA and EMA do not thermally decompose at temperatures up to approximately 330-360° C., the appearance of crosslinked substances called fish eyes is reduced compared with an ethylene vinyl acetate (EVA) copolymer, that thermally decomposes at 230-260° C. Further, a size of the sea-island structure is fine when sea-island structuring, and dispersion uniformity of the sea-island structure is excellent. As a result, the convex structure surface with moderate surface roughness can be formed more uniformly. In addition, it is easy to control changes in adhesion force by adjusting a content of EMMA.

In the film laminate to be applied to wheels of the present invention, the adhesive layer 2 is composed of an acrylic adhesive having excellent tack and having initial adhesive force and high retention, and in those illustrated in FIGS. 1 to 3, a solvent-based acrylic adhesive layer is formed on the base film 1 (back side in the figure). In addition, other synthetic rubber-based adhesives may be used if they are solvent-based pressure-sensitive adhesives. For example, the adhesive force according to JIS Z 0237 testing method is preferably 4.50 N or more at room temperature after the lapse of 30 seconds of adhesion. Acrylic adhesives that meet such criterion have excellent initial adhesion and post-adhesion retention especially on aluminum wheels, making it extremely difficult to remove the adhesive film, for example, even when the car is suddenly driven after the adhesive film has been adhered.

The acrylic adhesives include those in which monomers containing functional groups are copolymerized, with alkyl acrylate esters as a primary monomer. Examples of alkyl acrylate esters include ethyl acrylate, butyl acrylate, and 2-ethylhexyl acrylate. Examples of the monomers containing functional groups include acrylic acid, methacrylic acid, and hydroxyethyl methacrylate. Examples of the synthetic rubber-based adhesives include polyisobutylene, a styrene-ethylene·butylene-styrene block copolymer, a styrene-ethylene·propylene-styrene block copolymer, a styrene-isoprene-styrene block copolymer, and a styrene-butadiene-styrene block copolymer.

The acrylic adhesives can be suitably used from the viewpoint of the weather resistance and other properties. In particular, it is preferable to use an acrylic adhesive obtained by crosslinking an acrylic copolymer with a crosslinking agent such as a polyisocyanate crosslinking agent, an epoxy crosslinking agent, an aziridine crosslinking agent, and a chelating crosslinking agent.

A thickness of the adhesive layer 2 is not limited, but usually 3 to 100 μm is sufficient, preferably 5 to 60 μm.

The adhesive layer 2 can also contain the UV absorber so that the spectral transmittance in the wavelength range of 300 to 380 nm of the base film 1 is 0 to 20%. A content ratio of the UV absorber is preferably 0.01 to 10% by mass. Specific examples of the UV absorbers include those described above.

Furthermore, the adhesive layer 2 can contain one or more of a tackifier, a softener, an anti-aging agent, a filler, and a coloring agent such as a dye or pigment, as needed. Examples of tackifiers include a rosin-based resin, a terpene phenolic resin, a terpene resin, an aromatic hydrocarbon modified terpene resin, a petroleum resin, a coumarone·indene resin, a styrene resin, a phenolic resin, and a xylene resin. Examples of softeners include process oil, liquid rubber, and a plasticizer. Examples of fillers include silica, talc, clay, and calcium carbonate.

### EXAMPLES

Hereinafter, the film laminate to be applied to wheels of the present invention will be specifically described with reference to Examples.

### Example 1

Two sheets of film A to be applied to wheels were laminated to form a film laminate to be applied to wheels, in which an adhesive layer 2 having a thickness of 15 μm and composed of an acrylic adhesive (butyl acrylate (BA)·methyl methacrylate (MMA)·2-hydroxyethyl methacrylate (2-HEMA) copolymer) was formed on the back surface of the base film 1 having surface roughness of 0.10 μm in arithmetic mean roughness (Ra) and 1.0 μm in maximum height (Ry), and having a width of 25 mm, a length of 250 mm, and a thickness of 50 μm.

### Example 2

Two sheets of film A to be applied to wheels were laminated to form a film laminate to be applied to wheels, in which the adhesive layer 2 having a thickness of 15 μm and composed of the acrylic adhesive (BA·MMA·2-HEMA copolymer) was formed on the back surface of the base film 1 which was composed of: the first layer 13 having the surface roughness of 0.10 μm in arithmetic mean roughness (Ra) and 1.0 μm in maximum height (Ry), and having a width of 25 mm, a length of 250 mm, and a thickness of 7 μm; the second layer 14 having a smooth surface, and having a width of 25 mm, a length of 250 mm, and a thickness of 36 μm; and the third layer 15 having a smooth surface, and having a width of 25 mm, a length of 250 mm, and a thickness of 7 μm.

### Example 3

Two sheets of films A to be applied to wheels were laminated to form a film laminate to be applied to wheels, in which the adhesive layer 2 having a thickness of 15 μm and composed of the acrylic adhesive (BA·MMA·2-HEMA copolymer) was formed on the back surface of the base film 1 which was composed of: the first layer 13 having the surface roughness of 0.30 μm in arithmetic mean roughness (Ra) and 1.0 μm in maximum height (Ry), and having a width of 25 mm, a length of 250 mm, and a thickness of 10 μm; the second layer 14 having a smooth surface, and having a width of 25 mm, a length of 250 mm, and a thickness of 45 μm; and the third layer 15 having a smooth surface, and having a width of 25 mm, a length of 250 mm, and a thickness of 10 μm.

### Comparative Example 1

Two sheets of films A to be applied to wheels were laminated to form a film laminate to be applied to wheels, in which the adhesive layer 2 having a thickness of 15 μm and composed of the acrylic adhesive (BA·MMA·2-HEMA copolymer) was formed on the back surface of the base film 1 having the surface roughness of 0.03 μm in arithmetic mean roughness (Ra) and 0.3 μm in maximum height (Ry), and having a width of 25 mm, a length of 250 mm, and a thickness of 50 μm.

### Comparative Example 2

Two sheets of films A to be applied to wheels were laminated to form a film laminate to be applied to wheels, in which the adhesive layer 2 having a thickness of 15 μm and composed of the acrylic adhesive (BA·MMA·2-HEMA copolymer) was formed on the back surface of the base film 1 having the surface roughness of 0.04 μm in arithmetic mean roughness (Ra) and 0.3 μm in maximum height (Ry), and having a width of 25 mm, a length of 250 mm, and a thickness of 50 μm.

Using the film laminates to be applied to wheels of Examples 1 to 3 and Comparative Examples 1 and 2 described above, measurements were made of the peeling noise and the peeling charge voltage when a sheet of film A to be applied to wheels was peeled off from these film laminates to be applied to wheels. The measurement methods are as follows, and the measurement results are shown in Table 1.

### (Peeling Noise Measurement Method)

The peeling noise was measured with an integral normal noise meter (LA-220S, produced by Ono Sokki Co., Ltd.) when a sheet of film A to be applied to wheels was peeled off from the film laminates to be applied to wheels of Examples 1 to 3 and Comparative Examples 1 and 2, respectively, at a speed of 1,000 mm/min. All of these measurements were made under the condition of a temperature of 25° C. and a humidity of 50% R.H.

### (Peeling Charge Voltage Measurement Method)

The peeling charge voltage was measured with a handy-type electrostatic measuring instrument (FMX-003, produced by Simco Japan) when a sheet of film A to be applied to wheels was peeled off from the film laminates to be applied to wheels of Examples 1 to 3, and Comparative Examples 1 and 2, respectively, at a speed of 1,000 mm/min. All of these processes were carried out under the condition of a temperature of 25° C. and a humidity of 50% R.H.

TABLE 1

| | | Examples | | | Comparative Examples | |
|---|---|---|---|---|---|---|
| | | 1 | 2 | 3 | 1 | 2 |
| Structure | Base | Surface | Surface | Surface | Surface | Surface |
| | Film | Roughness | Roughness | Roughness | Roughness | Roughness |
| | | Ra 0.10 μm | Ra 0.10 μm | Ra 0.30 μm | Ra 0.03 μm | Ra 0.04 μm |
| | | Ry 1.0 μm | Ry 1.0 μm | Ry 1.0 μm | Ry 0.3 μm | Ry 0.3 μm |
| | | 1-Layer | 3-Layer | 3-Layer | 1-Layer | 1-Layer |
| | | Structure | Structure | Structure | Structure | Structure |
| | | | 1:5:1 | 1:5:1 | | |
| | | Thickness | Thickness | Thickness | Thickness | Thickness |
| | | 50 μm | 50 μm | 65 μm | 50 μm | 50 μm |
| | | | (7 μm, 36 μm, | (10 μm, 45 μm, | | |
| | | | 7 μm) | 10 μm) | | |
| | Adhesive | Acrylic | Acrylic | Acrylic Adhesive | Acrylic Adhesive | Acrylic |
| | Layer | Adhesive | Adhesive | | | Adhesive |
| | | BA•MMA•2- | BA•MMA•2- | BA•MMA.2- | BA•MMA•2- | BA•MMA•2- |
| | | HEMA | HEMA | HEMA | HEMA | HEMA |
| | | Copolymer | Copolymer | Copolymer | Copolymer | Copolymer |
| | | Thickness | Thickness | Thickness | Thickness | Thickness |
| | | 15 μm | 15 μm | 15 μm | 15 μm | 15 μm |
| Measurement | Peeling | 80 dB | 70 dB | 70 dB | 95 dB | 100 dB |
| Results | Noise | | | | | |
| | Peeling | 4.7 kV | 4.2 kV | 3.9 kV | 6.2 kV | 6.7 kV |
| | Charge | | | | | |
| | Voltage | | | | | |

### (Evaluation)

As shown in Table 1, the peeling noise was 80 dB in Example 1, 70 dB in Example 2, and 70 dB in Example 3, while it was 95 dB in Comparative Example 1 and 100 dB in Comparative Example 2. Therefore, it was confirmed that the peeling noise when a sheet of film A to be applied to wheels was peeled off from the film laminate to be applied to wheels of the present invention could be reduced by at least 15 dB.

The peeling charge voltage was 4.7 kV in Example 1, 4.2 kV in Example 2, and 3.9 kV in Example 3, while it was 6.2 kV in Comparative Example 1 and 6.7 kV in Comparative Example 2. Therefore, it was confirmed that the peeling charge voltage when a sheet of film A to be applied to wheels was peeled off from the film laminate to be applied to wheels of the present invention could be reduced by at least 1.5 kV.

### REFERENCE SIGNS LIST

1 base film
2 adhesive layer
13 first layer
14 second layer
15 third layer
17 micro-convex structure
A film to be applied to wheels

1. A film laminate to be applied to wheels comprising a plurality of film sheets to be applied to wheels, comprising a base film and an adhesive layer provided on the base film, the base film having a surface roughness of 0.05 to 1.50 μm in arithmetic mean roughness (Ra) and 0.25 to 2.50 μm in maximum height (Ry).

2. The film laminate to be applied to wheels according to claim 1, wherein the base film 1 comprises an additive to improve weather resistance.

3. The film laminate to be applied to wheels according to claim 1, wherein the base film is subjected to a treatment to improve adhesion with the adhesive layer.

4. The film laminate to be applied to wheels according to claim 1, wherein the base film comprises three layers of a first layer, a second layer, and a third layer.

5. The film laminate to be applied to wheels according to claim 4, wherein a thickness ratio of the first layer, the second layer, and the third layer of the base film is about 1:5:1.

6. The film laminate to be applied to wheels according to claim 4, wherein a surface of the first layer of the base film is formed into a micro-convex structure by sea-island structuring of a base resin and an incompatible resin.

7. The film laminate to be applied to wheels according to claim 2, wherein the base film is subjected to a treatment to improve adhesion with the adhesive layer.

8. The film laminate to be applied to wheels according to claim 2, wherein the base film comprises three layers of a first layer, a second layer, and a third layer.

9. The film laminate to be applied to wheels according to claim 3, wherein the base film comprises three layers of a first layer, a second layer, and a third layer.

10. The film laminate to be applied to wheels according to claim 5, wherein a surface of the first layer of the base film is formed into a micro-convex structure by sea-island structuring of a base resin and an incompatible resin.

11. The film laminate to be applied to wheels according to claim 7, wherein the base film comprises three layers of a first layer, a second layer, and a third layer.

12. The film laminate to be applied to wheels according to claim 11, wherein the base film comprises three layers of a first layer, a second layer, and a third layer.

13. The film laminate to be applied to wheels according to claim 12, wherein a surface of the first layer of the base film is formed into a micro-convex structure by sea-island structuring of a base resin and an incompatible resin.
